(19) United States
(12) Patent Application Publication
(10) Pub. No.: US 2025/0294386 A1
(43) Pub. Date: Sep. 18, 2025

(54) DYNAMIC CROSS-LINK INTERFERENCE MEASUREMENT AND REPORTING

(71) Applicant: Lenovo (Singapore) Pte. Limited, Singapore (SG)

(72) Inventor: Hyejung Jung, Northbrook, IL (US)

(73) Assignee: Lenovo (Singapore) Pte. Limited, Singapore (SG)

(21) Appl. No.: 18/859,799

(22) PCT Filed: Apr. 24, 2023
(86) PCT No.: PCT/IB2023/054197

§ 371 Date: Oct. 24, 2024

Related U.S. Application Data
(60) Provisional application No. 63/335,617, filed on Apr. 27, 2022.

(51) Int. Cl. H04W 24/08; H04L 5/00

(52) U.S. Cl. CPC H04W 24/08; H04L 5/0091

(57) ABSTRACT

Various aspects of the present disclosure relate to a user equipment (UE) that is configured, e.g., from a base station, with a set of spatial information for one or more cross-link interference (CLI) resources. The UE receives, e.g., from a base station, dynamic indication of spatial information, selected from the set of configured spatial information. The UE performs measurement using the indicated spatial information on the corresponding CLI resource and reports. e.g., to a base station, the measurement. The spatial information can be dynamically indicated in various manners, such as using media access control (MAC) control element (CE) signaling, downlink control information (DCI) signaling, and so forth.

### RELATED APPLICATION

This application claims priority to U.S. Patent Application Ser. No. 63/335,617 filed Apr. 27, 2022 entitled “Dynamic Cross-link Interference Measurement and Reporting,” the disclosure of which is incorporated by reference herein in its entirety.

### TECHNICAL FIELD

The present disclosure relates to wireless communications, and more specifically to cross-link interference (CLI) measurement and reporting.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Given the various network communication devices and user communication devices in a wireless communication system, situations can arise where these devices interfere with one another. For example, situations can arise in which two devices are operating in the same frequency band and the signals being transmitted interfere with one another, which is referred to as CLI. CLI measurement and reporting mechanisms are used to handle co-channel and adjacent channel interferences and UE-to-UE and base station-to-UE interferences.

### SUMMARY

The present disclosure relates to methods, apparatuses, and systems that support dynamic cross-link interference measurement and reporting. A UE is configured, e.g., from a base station, with a set of spatial information for one or more CLI resources. The UE receives, e.g., from a base station, dynamic indication of spatial information, selected from the set of configured spatial information. The UE performs measurement using the indicated spatial information on the corresponding CLI resource and reports, e.g., to a base station, the measurement. By utilizing the described techniques, a network entity is able to dynamically indicate an active spatial filter to be used for a UE to measure interference of various sources.

Some implementations of the method and apparatuses described herein may include wireless communication at a device (e.g., a UE), and the device receives, from a network entity, a first signaling identifying a CLI measurement configuration that includes at least one spatial information and at least one CLI resource; receives, from the network entity, a second signaling indicating to activate a spatial information of the at least one spatial information for a CLI resource of the at least one CLI resource; and performs measurements on the CLI resource based at least in part on the activated spatial information.

In some implementations of the method and apparatuses described herein, the spatial information of the at least one spatial information comprises an indication of a reference signal. Additionally or alternatively, the reference signal comprises a synchronization signal/physical broadcast channel block or a channel state information-reference signal resource. Additionally or alternatively, the spatial information of the at least one spatial information further comprises a serving cell index, wherein the reference signal is associated with a serving cell indicated by the serving cell index. Additionally or alternatively, the device further: determines, when the spatial information does not include a serving cell index, that the reference signal is associated with a primary cell. Additionally or alternatively, the device further: determines, when the spatial information does not include a serving cell index, that the reference signal is associated with a serving cell where the CLI measurement configuration is received. Additionally or alternatively, the second signaling comprises a medium access control (MAC) control element (CE). Additionally or alternatively, the device further performs measurements on the CLI resource in response to the indication to activate the spatial information for the CLI resource; Additionally or alternatively, the indication to activate the spatial information comprises an indication of an uplink resource for sending a CLI measurement report, and the device further: transmits, to the network entity, third signaling on the indicated uplink resource indicating the CLI measurement report. Additionally or alternatively, the second signaling indicates to activate semi-persistent signaling, and wherein to perform measurements is to perform semi-persistent measurements on the cross-link interference resource based at least in part on the activated spatial information. Additionally or alternatively, the second signaling indicates to activate aperiodic signaling, and wherein to perform measurements is to perform aperiodic measurements on the cross-link interference resource based at least in part on the activated spatial information. Additionally or alternatively, the network entity comprises a base station.

Some implementations of the method and apparatuses described herein may include wireless communication at a device (e.g., a UE), and the device transmits, to a UE, a first signaling identifying a CLI measurement configuration that includes at least one spatial information and at least one CLI resource; and transmits, to the UE, a second signaling indicating to activate a spatial information of the at least one spatial information for a CLI resource of the at least one CLI resource.

In some implementations of the method and apparatuses described herein, the spatial information of the at least one spatial information comprises an indication of a reference signal. Additionally or alternatively, the reference signal comprises a synchronization signal/physical broadcast channel block or a channel state information-reference signal resource. Additionally or alternatively, the spatial information of the at least one spatial information further comprises a serving cell index, wherein the reference signal is associated with a serving cell indicated by the serving cell index. Additionally or alternatively, the second signaling comprises a MAC CE. Additionally or alternatively, the indication to activate the spatial information comprises an indication of an uplink resource for sending a CLI measurement report, and the device further: receives, from the UE, third signaling on the indicated uplink resource indicating the CLI measurement report. Additionally or alternatively, the second signaling indicates to activate semi-persistent signaling to receive semi-persistent CLI measurement reports from the UE. Additionally or alternatively, the second signaling indicates to activate aperiodic signaling to receive an aperiodic CLI measurement report from the UE. Additionally or alternatively, the device comprises a base station.

### BRIEF DESCRIPTION OF THE DRAWINGS

Various aspects of the present disclosure for dynamic cross-link interference measurement and reporting are described with reference to the following Figures. The same numbers may be used throughout to reference like features and components shown in the Figures.

FIG. 1 illustrates an example of a wireless communications system that supports dynamic cross-link interference measurement and reporting in accordance with aspects of the present disclosure.

FIGS. 2A, 2B, 2C, and 2D illustrate an example of an information element that supports dynamic cross-link interference measurement and reporting in accordance with aspects of the present disclosure.

FIG. 3-5 illustrate examples of MAC CEs that support dynamic cross-link interference measurement and reporting in accordance with aspects of the present disclosure.

FIGS. 6A and 6B illustrates an example of an information element that supports dynamic cross-link interference measurement and reporting in accordance with aspects of the present disclosure.

FIG. 7 illustrates an example block diagram of components of a device (e.g., a UE) that supports dynamic cross-link interference measurement and reporting in accordance with aspects of the present disclosure.

FIG. 8 illustrates an example block diagram of components of a device (e.g., a base station, or other network device or network entity) that supports dynamic cross-link interference measurement and reporting in accordance with aspects of the present disclosure.

FIG. 9-12 illustrate flowcharts of methods that support dynamic cross-link interference measurement and reporting in accordance with aspects of the present disclosure.

### DETAILED DESCRIPTION

Implementations of dynamic cross-link interference measurement and reporting are described. A UE is configured, e.g., from a base station, with a set of spatial information for one or more CLI resources. The UE receives, e.g., from a base station, dynamic indication of spatial information, selected from the set of configured spatial information. The UE performs measurement using the indicated spatial information on the corresponding CLI resource and reports, e.g., to a base station, the measurement.

In one or more implementations, the dynamic indication is provided using MAC CE signaling. A network entity, such as a base station, transmits a MAC CE to the UE indicating activation or deactivation of spatial information for a CLI resource or a CLI resource group.

Additionally or alternatively, the dynamic indication is provided using downlink control information (DCI) signaling. A network entity, such as a bases stations, transmits an indication in DCI to trigger CLI measurements on a particular CLI resource(s) and an indication for an uplink resource for CLI measurement reporting. The UE performs CLI measurements on the indicated or activated CLI resource(s) (with corresponding activated spatial information, if configured) on a semi-persistent or aperiodic basis, and sends a CLI measurement report in the indicated uplink resource.

The UE has different spatial filters that, for example, allow the UE to perform beam forming. The interference level experienced by the UE may vary greatly from beam to beam. Conventional CLI measurement and reporting mechanisms consider neither potentially different interference levels measured by a UE with different spatial filters used for interference measurements nor dynamic changes in operating beams during communication. Furthermore, conventional CLI measurement and reporting mechanisms enable only long-term interference measurements and reporting, while the UE may observe significantly varying interference-level with dynamic beam changes in UE's serving beams and/or aggressors' operating beams. This disclosure discusses enhanced CLI measurement and reporting techniques that consider dynamic changes of operating beams and corresponding impact on observed interference levels. A network entity (e.g., a base station) is able to dynamically indicate an active spatial filter to be used for a UE to measure interference of various sources. Further, the network entity can dynamically trigger CLI measurements to assess short-term interference level with dynamic operating beam changes.

In various wireless network deployment scenarios, CLI including co-channel and/or adjacent channel interferences and user equipment UE-to-UE and/or base station-to-UE interferences can occur. With multiple beam-based cell operation, UE-to-UE, inter-cell and/or intra-cell interferences may be effectively mitigated with proper selections of a served UE, a serving beam, and a corresponding receive beam at the UE.

Aspects of the present disclosure are described in the context of a wireless communications system. Aspects of the present disclosure are further illustrated and described with reference to device diagrams and flowcharts that relate to dynamic cross-link interference measurement and reporting.

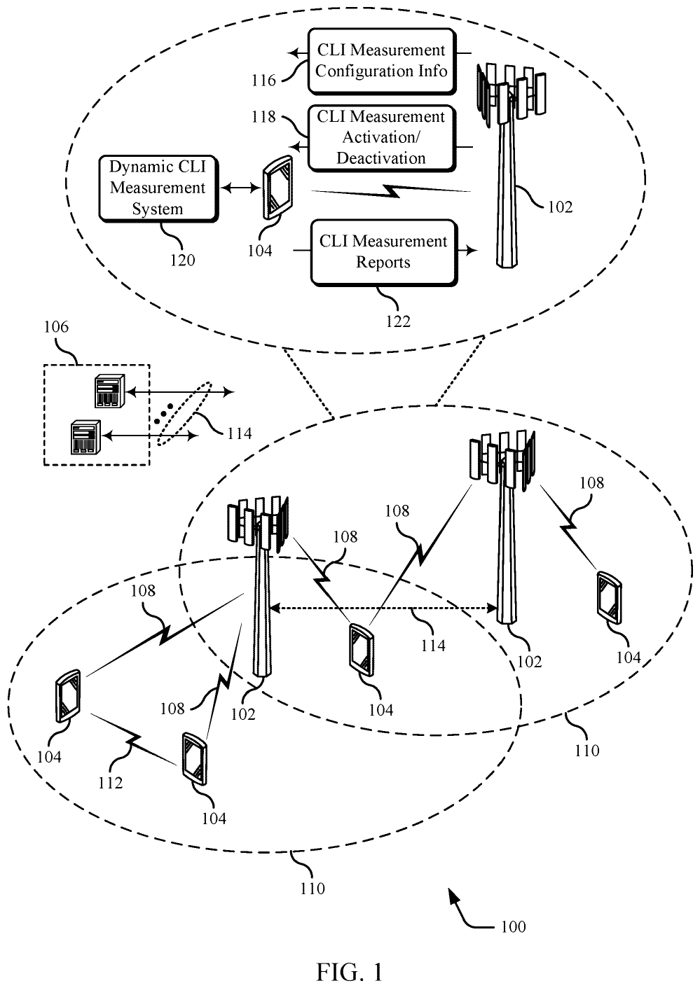

FIG. 1 illustrates an example of a wireless communications system 100 that supports dynamic cross-link interference measurement and reporting in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

In one or more implementations, the base station 102 transmits CLI measurement configuration information 116 describing spatial CLI measurement and reporting to the UE 104. This configuration information identifies one or more CLI resources, such as at least one of an sounding reference signals (SRS) resource, an RSSI resource, a CLI resource group, and so forth. The configuration information also includes one or more spatial information for each CLI resource. The base station 102 also transmits a CLI measurement activation or deactivation 118 to the UE 104. The CLI measurement activation is an indication to activate one of the spatial information indicated in the CLI measurement configuration information 116. The CLI measurement deactivation is an indication to deactivate one of the spatial information indicated in the CLI measurement configuration information 116.

In response to an indication to activate one of the spatial information, a dynamic CLI measurement system 120 on the UE 104 performs measurements on the CLI resource based on the activated spatial information. The UE 104 returns these measurements to the base station 102 as CLI measurement reports 122. In response to an indication to deactivate one of the spatial information, the dynamic CLI measurement system 120 on the UE 104 ceases performing measurements on the CLI resource based on the deactivated spatial information but starts performing measurements on the CLI resource based on a newly activated spatial information.

In one or more implementations, two types of CLI measurements, SRS reference signal received power (SRS-RSRP) and CLI reference signal strength indicator (CLI-RSSI), may be used. As discussed in 3rd Generation Partnership Project (3GPP) technical specification (TS) 38.215, SRS-RSRP is defined as linear average of power contributions (in Watt) of resource elements carrying SRS. SRS-RSRP is measured over the configured resource elements within a considered measurement frequency bandwidth in configured measurement time occasions. CLI-RSSI is defined as linear average of the total received power (in Watt) observed only in configured OFDM symbols of a configured measurement time resource(s), in a configured measurement bandwidth from all sources, including co-channel serving and non-serving cells, adjacent channel interference, thermal noise, etc. For frequency range 1, the reference point for the measurements can be the antenna connector of a UE 104. For frequency range 2, the measurements can be done based on combined signal from antenna elements corresponding to a given receiver branch. For frequency range 1 and 2, if receiver diversity is in use by the UE 104, the reported measurement value may not be lower than the corresponding measurement value of any of the individual receiver branches.

SRS resources configured for SRS-RSRP measurement for CLI in a downlink (DL) bandwidth part (BWP) comprise subcarrier spacing same as subcarrier spacing of the DL BWP. A UE 104 may not be expected to measure SRS-RSRP using a SRS-RSRP measurement resource which is not fully confined within the DL BWP. The UE 104 may not be expected to measure more than 32 SRS resources, and the UE 104 may not be expected to receive more than 8 SRS resources in a slot.

The UE 104 can be configured with a list of up to M TOI-State configurations within the higher layer parameter PDSCH-Config to decode physical downlink shared channel (PDSCH) according to a detected physical downlink control channel (PDCCH) with DCI intended for the UE and the given serving cell, where M depends on the UE capability maxNumberConfiguredTCIstatesPerCC. Each TOI-State contains parameters for configuring a quasi co-location relationship between one or two downlink reference signals and the demodulation reference signal (DM-RS) ports of the PDSCH, the DM-RS port of PDCCH or the channel state information-reference signal (CSI-RS) port(s) of a CSI-RS resource. The quasi co-location relationship is configured by the higher layer parameter qcl-Type 1 for the first DL reference signal (RS), and qcl-Type 2 for the second DL RS (if configured). For the case of two DL RSs, the quasi-co-location (QCL) types may not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 DLorJointTCIState configurations, within the higher layer parameter PDSCH-Config for providing a reference signal for the quasi co-location for DM-RS of PDSCH and DM-RS of PDCCH in a CC, for CSI-RS, and to provide a reference, if applicable, for determining uplink (UL) transmit (TX) spatial filter for dynamic-grant and configured-grant based physical uplink shared channel (PUSCH) and physical uplink control channel (PUCCH) resource in a CC, and SRS.

If the DLorJointTCIState or UL-TCIState configurations are absent in a BWP of the CC, the UE 104 can apply the DLorJointTCIState or UL-TCIState configurations from a reference BWP of a reference CC. The UE 104 is not expected to be configured with TCI-State, SpatialRelationInfo or PUCCH-SpatialRelationInfo, except SpatialRelationInfoPos in a CC in a band, if the UE 104 is configured with DLorJointTCIState or UL-TCIState in any CC in the same band. The UE 104 can assume that when the UE 104 is configured with TCI-State in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE 104 is not configured with DLorJointTCIState or UL-TCIState in any CC within the same band in the CC list.

The UE 104 receives an activation command, as described in clause 6.1.3.14 of 3GPP TS 38.321 or 6.1.3.x of 3GPP TS 38.321, used to map up to 8 transmission configuration indicator (TCI) states and/or pairs of TCI states, with one TCI state for DL channels/signals and one TCI state for UL channels/signals to the codepoints of the DCI field ‘Transmission Configuration Indication’ for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs.

When the bwp-id or cell for QCL-TypeA/D source RS in a QCL-Info of the TCI state configured with DLorJointTCIState is not configured, the UE 104 assumes that QCL-TypeA/D source RS is configured in the CC/DL BWP where TCI state applies.

When tci-PresentInDCI is set as ‘enabled’ or tci-PresentDCI-1-2 is configured for the control resource set (CORESET), the UE 104 with activated DLorJointTCIState or UL-TCI-State receives DCI format 1_1/1_2 providing indicated DLorJointTOIState or UL-TCIState for a CC or all CCs in the same CC list configured by simultaneousTOI-UpdateList1-r17, simultaneousTOI-UpdateList2-r17, simultaneousTCI-UpdateList3-r17, simultaneousTCI-UpdateList4-r17. The DCI format 1_1/1_2 can be with or without, if applicable, DL assignment. If the DCI format 1_1/1_2/ is without DL assignment, the UE 104 can assume the following: 1) CS-RNTI is used to scramble the cyclic redundancy check (CRC) for the DCI; 2) the values of the following DCI fields are set as follows: RV=all ‘l’s; modulation and coding scheme (MCS)=all ‘1’s; new data indicator (NDI)=0; set to all ‘0’s for frequency domain resource allocation (FDRA) Type 0, or all ‘1’s for FDRA Type 1, or all ‘0’s for dynamicSwitch (same as in Table 10.2-4 of 3GPP TS 38.213).

When the UE 104 would transmit a PUCCH with hybrid automatic repeat request-acknowledgement (HARQ-ACK) information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{subframe , μ} + \frac{{2}^{μ}}{{2}^{{μ}_{{K}_{mac}}}} \cdot {k}_{m a c}$$

where μ is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE 104 receives an initial higher layer configuration of TCI states and before reception of the activation command, the UE 104 may assume that the DM-RS ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

If a UE 104 is configured with the higher layer parameter tci-PresentInDCI that is set as ‘enabled’ for the CORESET scheduling a PDSCH, the UE 104 assumes that the TCI field is present in the DCI format 1_1 of the PDCCH transmitted on the CORESET. If a UE 104 is configured with the higher layer parameter tci-PresentDCI-1-2 for the CORESET scheduling the PDSCH, the UE 104 assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE 104 capability as in 3GPP TS 38.306, for determining PDSCH antenna port quasi co-location, the UE 104 assumes that the TCI state or the QCL assumption for the PDSCH is identical to the TCI state or QCL assumption whichever is applied for the CORESET used for the PDCCH transmission within the active BWP of the serving cell.

For PDSCH scheduled by DCI format 1_0, 1_1, 1_2, when a UE 104 is configured with sfnSchemePdcch set to ‘sfnSchemeA’ and sfnSchemePdsch is not configured, and there is no TCI codepoint with two TCI states in the activation command, and if the time offset between the reception of the DL DCI and the corresponding PDSCH is equal or larger than the threshold timeDurationForQCL if applicable and the CORESET which schedules the PDSCH is indicated with two TCI states, the UE 104 assumes that the TCI state or the QCL assumption for the PDSCH is identical to the first TCI state or QCL assumption which is applied for the CORESET used for the PDCCH transmission within the active BWP of the serving cell.

If a PDSCH is scheduled by a DCI format having the TCI field present, the TCI field in DCI in the scheduling component carrier points to the activated TCI states in the scheduled component carrier or DL BWP, the UE 104 shall use the TCI-State according to the value of the ‘Transmission Configuration Indication’ field in the detected PDCCH with DCI for determining PDSCH antenna port quasi co-location. The UE 104 may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE 104 capability as discussed in 3GPP TS 38.306. For a single slot PDSCH, the indicated TCI state(s) should be based on the activated TCI states in the slot with the scheduled PDSCH. For a multi-slot PDSCH or the UE 104 is configured with higher layer parameter [pdsch-TimeDomainAllocationListForMultiPDSCH-r17], the indicated TCI state(s) should be based on the activated TCI states in the first slot with the scheduled PDSCH(s), and the UE 104 shall expect the activated TCI states are the same across the slots with the scheduled PDSCH(s). When the UE 104 is configured with CORESET associated with a search space set for cross-carrier scheduling and the UE 104 is not configured with enableDefaultBeamForCCS, the UE 104 expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE 104 expects the time offset between the reception of the detected PDCCH in the search space set and a corresponding PDSCH is larger than or equal to the threshold time DurationForQCL.

Independent of the configuration of tci-PresentInDCI and tci-PresentDCI-1-2 in radio resource control (RRC) connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’, the UE 104 may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE 104. In this case, if the qcl-Type is set to ‘typeD’ of the PDSCH DM-RS is different from that of the PDCCH DM-RS with which they overlap in at least one symbol, the UE 104 is expected to prioritize the reception of PDCCH associated with that CORESET. This also applies to the intra-band carrier aggregation (CA) case (when PDSCH and the CORESET are in different component carriers).

If a UE 104 is configured with enableDefaultTCI-StatePerCoresetPoolIndex and the UE 104 is configured by higher layer parameter PDC CH-Config that contains two different values of coresetPoolIndex in different ControlResourceSets, the UE 104 may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE 104. In this case, if the ‘QCL-TypeD’ of the PDSCH DM-RS is different from that of the PDCCH DM-RS with which they overlap in at least one symbol and they are associated with same value of coresetPoolIndex, the UE 104 is expected to prioritize the reception of PDCCH associated with that CORESET. This also applies to the intra-band CA case (when PDSCH and the CORESET are in different component carriers).

If a UE 104 is configured with enableTwoDefaultTCI-States, and at least one TCI codepoint indicates two TCI states, the UE 104 may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE 104 is configured by higher layer parameter repetitionScheme set to ‘tdmSchemeA’ or is configured with higher layer parameter repetitionNumber, and the offset between the reception of the DL DCI and the first PDSCH transmission occasion is less than the threshold timeDurationForQCL, the mapping of the TCI states to PDSCH transmission occasions is determined according to clause 5.1.2.1 of 3GPP TS 38.214 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE 104 is expected to prioritize the reception of PDCCH associated with that CORESET. This also applies to the intra-band CA case (when PDSCH and the CORESET are in different component carriers)

If a UE 104 is not configured with sfnSchemePdsch, and the UE 104 is configured with sfnSchemePdcch set to ‘sfnSchemeA’ and there is no TCI codepoint with two TCI states in the activation command and the CORESET with the lowest ID in the latest slot is indicated with two TCI states, the UE 104 may assume that the DM-RS ports of PDSCH of a serving cell are quasi co-located with the RS(s) with respect to the QCL parameter(s) associated with the first TCI state of two TCI states indicated for the CORESET.

In all cases above, if none of configured TCI states for the serving cell of scheduled PDSCH is configured with qcl-Type set to ‘typeD’, the UE 104 shall obtain the other QCL assumptions from the indicated TCI state(s) for its scheduled PDSCH irrespective of the time offset between the reception of the DL DCI and the corresponding PDSCH.

If the PDCCH carrying the scheduling DCI is received on one component carrier, and a PDSCH scheduled by that DCI is on another component carrier: the timeDurationForQCL is determined based on the subcarrier spacing of the scheduled PDSCH, if μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1 of 3GPP TS 38.214, otherwise d is zero; when the UE 104 is configured enableDefaultBeamForCCS, if the offset between the reception of the DL DCI and the corresponding PDSCH is less than the threshold timeDurationForQCL, or if the DL DCI does not have the TCI field present, the UE 104 obtains its QCL assumption for the scheduled PDSCH from the activated TCI state with the lowest ID applicable to PDSCH in the active BWP of the scheduled cell.

A UE 104 that has indicated a capability beamCorrespondenceWithoutUL-BeamSweeping set to ‘1’, as described in 3GPP TS 38.822, can determine a spatial domain filter to be used while performing the applicable channel access procedures described in 3GPP TS 37.213 to transmit a UL transmission on the channel as follows: if the UE 104 is indicated with an SRS resource indicator (SRI) corresponding to the UL transmission, the UE 104 may use a spatial domain filter that is same as the spatial domain transmission filter associated with the indicated SRI; if the UE 104 is configured with TOI-State configurations with DLorJointTCIState or UL-TCIState, the UE 104 may use a spatial domain transmit filter that is same as the spatial domain receive filter the UE 104 may use to receive the DL reference signal associated with the indicated TCI state.

When the PDCCH reception includes two PDCCH from two respective search space sets, as described in clause 10.1 of TS 38.213, for the purpose of determining the time offset between the reception of the DL DCI and the corresponding PDSCH, the PDCCH candidate that ends later in time is used. When the PDCCH reception includes two PDCCH candidates from two respective search space sets, as described in clause 10.1 of TS 38.213, for the configuration of tci-PresentInDCI or tci-PresentDCI-1-2, the UE 104 expects the same configuration in the first and second CORESETs associated with the two PDCCH candidates; and if the PDSCH is scheduled by a DCI format not having the TCI field present and if the scheduling offset is equal to or larger than timeDurationForQCL, if applicable, PDSCH QCL assumption is based on the CORESET with lower ID among the first and second CORESETs associated with the two PDCCH candidates.

In one or more implementations, a UE 104 receives configuration information and a dynamic indication of spatial CLI measurement and reporting. The UE 104 receives this configuration information and dynamic indication from a network entity or device, such as a base station 102.

The configuration information received by the UE includes a list of CLI spatial information, which in one or more implementations includes a service cell ID and a reference signal on which CLI measurement is to be performed. In one or more implementations, the dynamic indication includes an indication of particular spatial information from the list of CLI spatial information included in the configuration information.

In one or more implementations, a UE 104 receives configuration of a set of spatial information (e.g., cli-SpatialInfoList-r18 as discussed in more detail below) for CLI measurements, and further receives an indication of spatial information selected from the configured set of spatial information for a given CLI resource or for a given CLI resource group.

Additionally or alternatively, a UE 104 receives an indication to trigger CLI measurements on a particular CLI resource(s) and an indication for an uplink resource for CLI measurement reporting, performs CLI measurements on the indicated or activated CLI resource(s) (with corresponding activated spatial information, if configured), and sends a CLI measurement report in the indicated uplink resource. In an example, the indication to trigger CLI measurements on the particular CLI resource(s) and activate the CLI resource(s) with corresponding spatial information is received in downlink control information (DCI). The DCI may include a bitfield indicating an activated spatial information and/or a bitfield indicating an activated CLI resource. Additionally or alternatively, the DCI may include a bitfield jointly indicating an activated spatial information and a corresponding activated CLI resource.

Spatial information at a UE 104 may be activated or deactivated for a CLI resource or a CLI resource group.

In one or more implementations, a network entity (e.g., a base station 102) activates and deactivates a spatial information for a CLI resource or a CLI resource group (if one or more CLI resource groups are configured) by sending a CLI resource spatial information activation/deactivation Medium Access Control (MAC) Control Element (CE). If a MAC entity of a UE receives a CLI resource spatial information activation/deactivation MAC CE on a serving cell, the MAC entity indicates to lower layers the information regarding the CLI resource spatial information activation/deactivation MAC CE.

In one or more implementations, after a UE 104 receives an initial higher layer configuration of more than one CLI-SpatialInfo and before application of an indicated spatial information from the configured spatial information to a CLI resource: the UE 104 assumes that a DL receive (RX) spatial filter for reception of the CLI resource is the same as that for reception of a SS/PBCH block (SSB) the UE identified and selected (e.g., for random access procedure) during an initial access procedure.

Additionally or alternatively, if a UE 104 receives a higher layer configuration of a single CLI-SpatialInfo, that can be used as an indicated spatial information for a CLI resource(s) of a given CLI measurement object, the UE 104 assumes that a DL RX spatial filter for reception of the CLI resource(s) is the same as that for reception of a reference signal in the configured CLI-SpatialInfo.

Additionally or alternatively, when a UE 104 would transmit the last symbol of a physical uplink control channel (PUCCH) with Hybrid Automatic Repeat Request-Acknowledgement (HARQ-ACK) information corresponding to DCI indicating activation of a set of CLI resources with a corresponding set of active spatial information and without DL assignment, or corresponding to a PDSCH carrying a CLI spatial information activation/deactivation indication, and if at least one activated CLI spatial information is different from the previously activated one, the newly activated spatial information is applied starting from the first slot that is at least X symbols (e.g. X denotes a predefined value) after the last symbol of the PUCCH. The first slot and the X symbols are both determined based on SRS subcarrier spacing (SCS) for a CLI SRS resource and based on RSSI SCS for a CLI RSSI resource.

Example implementations to configure one or more spatial information for one or more CLI resources and to dynamically indicate corresponding spatial information for each of the one or more CLI resources are discussed below.

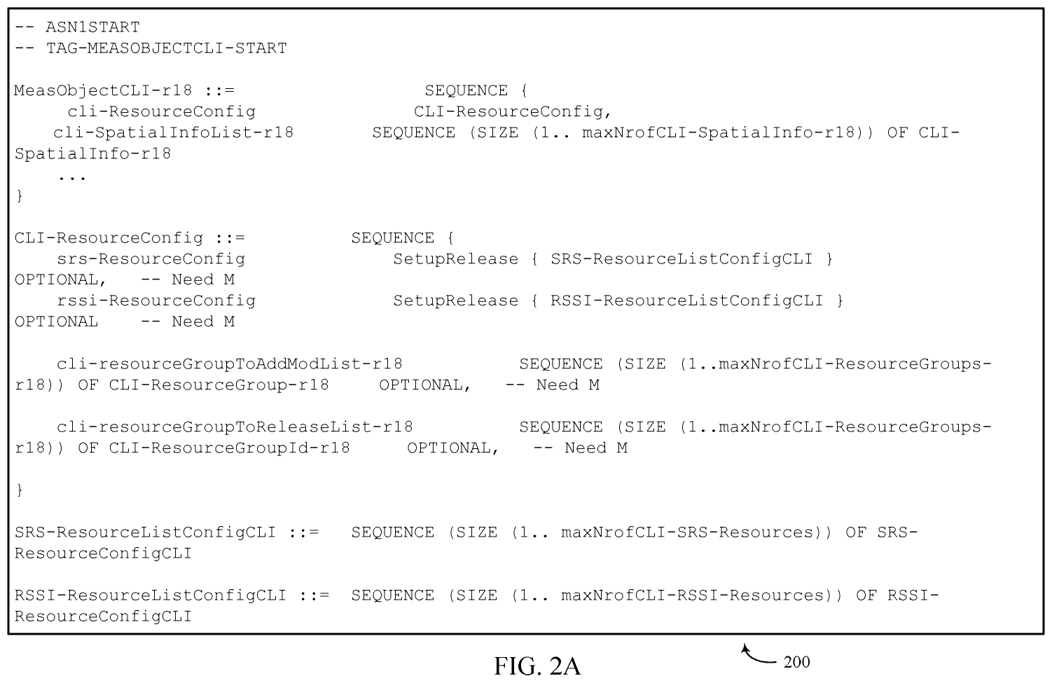

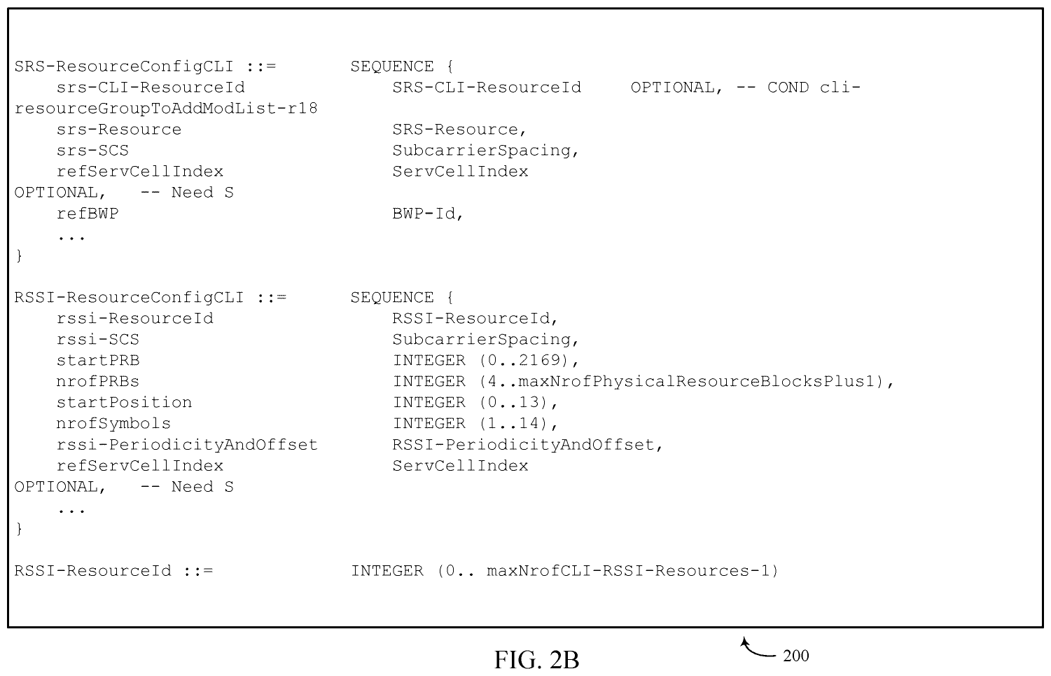

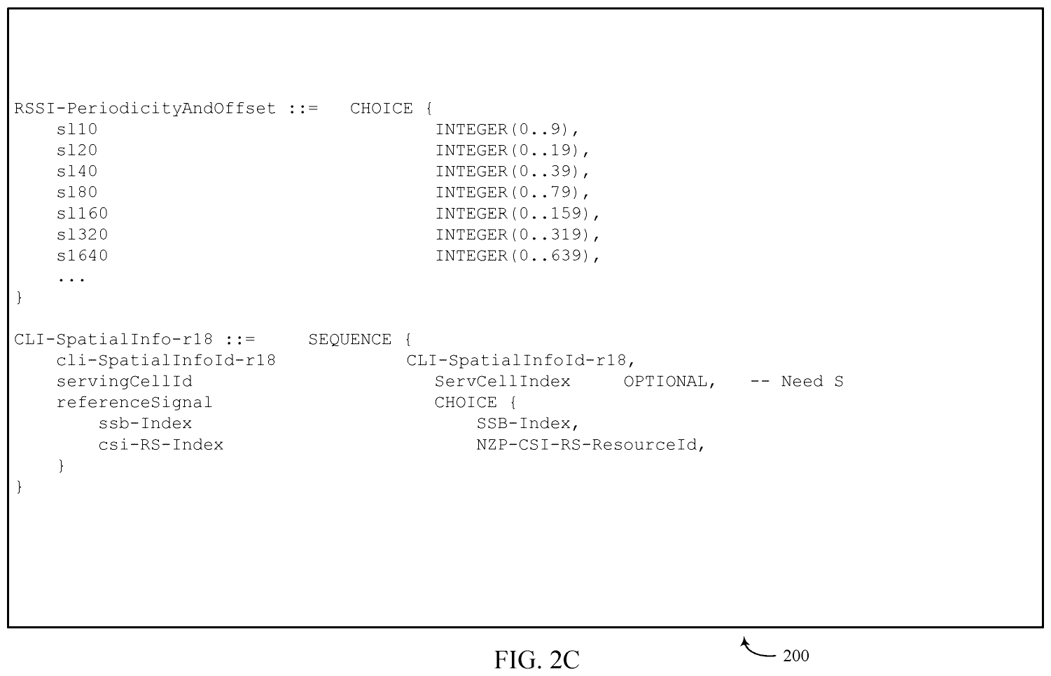

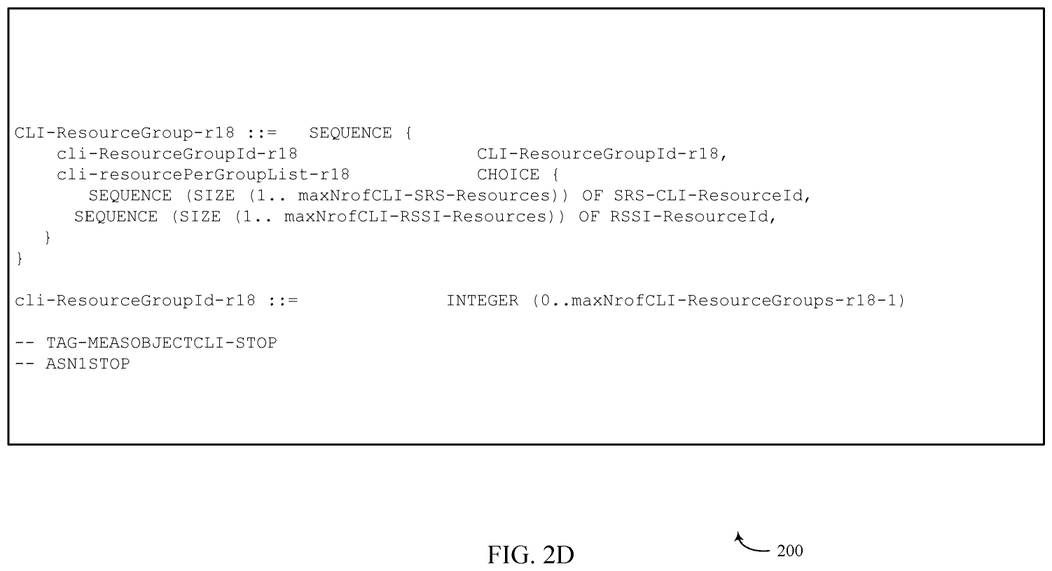

FIGS. 2A, 2B, 2C, and 2D illustrate an example of an information element 200 that supports dynamic cross-link interference measurement and reporting in accordance with aspects of the present disclosure. The information element 200 is illustrated as an MeasObjectCLI or MeasObjectCLI-r18 information element. The information element 200 specifies information applicable for SRS-RSRP measurements and/or CLI-RSSI measurements. The information element 200 serves, for example, as a CLI measurement configuration. The network (e.g., base station 102) configures a list of spatial information for a set of CLI resources, as indicated by the information element 200, via RRC signaling as discussed in more detail below, and further transmits an activation/deactivation indication via a MAC CE or DCI.

The information element 200 includes an srs-ResourceConfig field, which describes SRS resources to be used for CLI measurements. The information element 200 also includes an rssi-ResourceConfig field, which describes CLI-RSSI resources to be used for CLI measurements.

The information element 200 also includes a cli-SpatialInfo or CLI-SpatialInfo-r18 field, which identifies spatial information to be used for by a UE 104 for CLI measurements. The UE 104 uses, for CLI measurements, a DL RX filter that is the same as one used for receiving an indicated reference signal of an indicated serving cell. If the field servingCellId is absent, the UE 104 applies the ServCellId of the serving cell in which this cli-SpatialInfo is configured. Additionally or alternatively, if the field servingCellId is absent, the UE 104 applies the ServCellId of PCell.

The SpatialInfo-r18 field may also include a referenceSignal field that specifies a reference signal for which CLI measurements are performed. The reference signal may be, for example, an SSB signal or a CSI-RS signal.

The information element 200 may also include a CLI-ResourceGroup or CLI-ResourceGroup-r18, which identifies a group of CLI resources. This allows, for example, a group of CLI resources to be activated or deactivated rather than an individual CLI resource.

The information element 200 also includes an SRS-ResourceConfigCLI field. The SRS-ResourceConfigCLI identifies an refBWP field, an refServCellIndex field, and an srs-SCS field. The refBWP field includes a DL BWP id that is used to derive the reference point of the SRS resource. The refServCellIndex field identifies the index of the reference serving cell that the refBWP belongs to. If this field is absent, the reference serving cell is PCell. The srs-SCS field identifies subcarrier spacing for SRS. In one or more implementations, the values 15, 30 kHz or 60 kHz (FR1), and 60 or 120 kHz (FR2) are applicable.

The information element 200 also includes an RSSI-ResourceConfigCLI field. The RSSI-ResourceConfigCLI field includes a nrofPRBs field, a nrofSymbols field, a refServCellIndex field, a rssi-PeriodicityAndOffset field, a rssi-SCS field, a startPosition field, and a startPRB field. The nrofPRBs field identifies an allowed size of the measurement BW. In one or more implementations, multiples of 4 are allowed. The smallest configurable number is a minimum (e.g., a minimum of 4) and the width of the active DL BWP. If the configured value is larger than the width of the active DL BWP, the UE 104 assumes that the actual CLI-RSSI resource bandwidth is within the active DL BWP.

For the nrofSymbols field, within a slot that is configured for CLI-RSSI measurement (see slotConfiguration), the UE 104 measures the RSSI from startPosition to startPosition+nrofSymbols−1. The configured CLI-RSSI resource does not exceed the slot boundary of the reference SCS. If the SCS of configured DL BWP(s) is larger than the reference SCS, the network configures startPosition and nrofSymbols such that the configured CLI-RSSI resource not to exceed the slot boundary corresponding to the configured BWP SCS. If the reference SCS is larger than SCS of configured DL BWP(s), network ensures startPosition and nrofSymbols are integer multiple of reference SCS divided by configured BWP SCS.

The refServCellIndex field identifies the index of the reference serving cell. Frequency reference point of the RSSI resource is subcarrier 0 of CRB0 of the reference serving cell. If this field is absent, the reference serving cell is PCell.

The rssi-PeriodicityAndOffset field identifies the periodicity and slot offset for this CLI-RSSI resource. All values are in “number of slots”. Value sl1 corresponds to a periodicity of 1 slot, value s/2 corresponds to a periodicity of 2 slots, and so on. For each periodicity the corresponding offset is given in number of slots.

The rssi-SCS field identifies a reference subcarrier spacing for CLI-RSSI measurement. In one or more implementations the values 15, 30 kHz or 60 kHz (FR1), and 60 or 120 kHz (FR2) are applicable. The UE 104 performs CLI-RSSI measurement with the SCS of the active bandwidth part within the configured CLI-RSSI resource in the active BWP regardless of the reference SCS of the measurement resource.

The startPosition field identifies an orthogonal frequency division multiplexing (OFDM) symbol location of the CLI-RSSI resource within a slot.

The startPRB field identifies a starting physical resource block (PRB) index of the measurement bandwidth. For the case where the reference subcarrier spacing is smaller than subcarrier spacing of active DL BWP(s), network configures startPRB and nrofPRBs are as a multiple of active BW SCS divided by reference SCS.

Returning to FIG. 1, in one or more implementations CLI resource spatial information activation or deactivation is done using a MAC CE. The CLI resource spatial information activation or deactivation MAC CE is identified by a MAC subheader with a predefined logical channel identity (LCID). In one example implementation, the MAC CE has a size of 16 bits (e.g., for a CLI RSSI resource) or a size of 24 bits (e.g., for a CLI SRS resource).

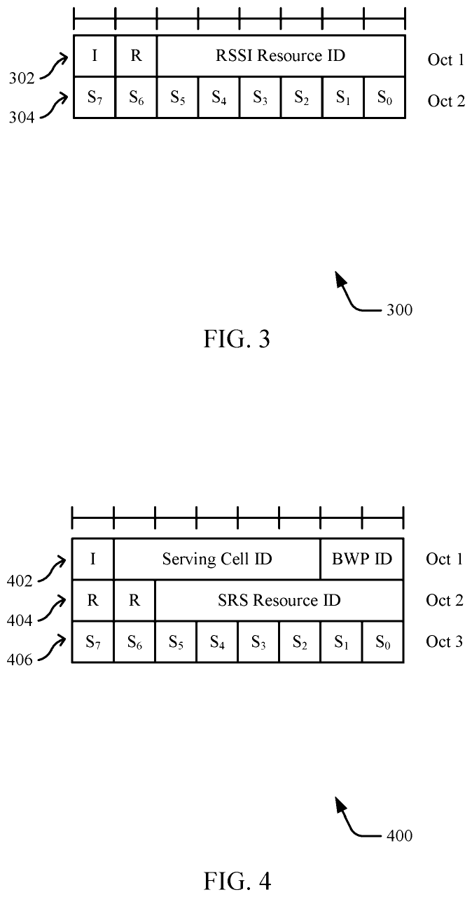

FIG. 3 illustrates an example of a MAC CE 300 that supports dynamic cross-link interference measurement and reporting in accordance with aspects of the present disclosure. The MAC CE 300 is a spatial information activation/deactivation MAC CE for CLI measurement on a RSSI resource.

FIG. 4 illustrates an example of a MAC CE 400 that supports dynamic cross-link interference measurement and reporting in accordance with aspects of the present disclosure. The MAC CE 400 is a spatial information activation/deactivation MAC CE for CLI measurement on a SRS resource.

The MAC CE 300 of FIG. 3 includes an octet 302 and an octet 304 including an I field, an R field, eight Sᵢ fields, and an RSSI Resource ID field. These fields are discussed in more detail below. The MAC CE 400 of FIG. 4 includes an octet 402, an octet 404, and an octet 406 including an I field, two R field, eight Sᵢ fields, a Serving Cell ID field, a BWP ID field, and an SRS Resource ID field.

The I field indicates a CLI resource type. In the illustrated example, if set to 0, the MAC CE with the size of 24 bits is for CLI measurement on a SRS resource. If set to 1, the MAC CE with the size of 16 bits is for CLI measurement on a RSSI resource.

The Serving Cell ID field indicates an identity of a reference serving cell for a SRS resource. In the illustrated example, the length of the field is 5 bits.

The BWP ID field indicates a DL BWP that is used to derive a reference point of the SRS resource. In the illustrated example, the length of the BWP ID field is 2 bits.

The SRS Resource ID field contains an identifier of a SRS resource ID identified by SRS-ResourceId. In the illustrated example, the length of the field is 6 bits.

The RSSI Resource ID field contains an identifier of a RSSI resource ID identified by RSSI-ResourceId. In the illustrated example, the length of the field is 6 bits.

For the Sᵢ fields, if in MeasObjectCLI in which the RSSI Resource ID or SRS Resource ID is configured as a CLI resource, there is a CLI Spatial information with CLI-SpatialInfold, configured, Sᵢ indicates the activation status of CLI spatial information with CLI-SpatialInfold equal to i+1 for the CLI resource, otherwise MAC entity shall ignore this field. The Sᵢ field is set to 1 to indicate CLI Spatial information with CLI-SpatiaInfold equal to i+1 shall be activated for the CLI resource. The Sᵢ field is set to 0 to indicate CLI Spatial information with CLI-SpatialInfold equal to i+1 shall be deactivated for the CLI resource. In one or more implementations a single Spatial information can be active for a given CLI Resource at a time;

The R field is a Reserved bit, e.g., set to 0.

Returning to FIG. 1, in one or more implementations CLI resource group spatial information activation or deactivation is done using an extended MAC CE. The extended CLI resource group spatial information activation or deactivation MAC CE is identified by a MAC subheader with a predefined LCID.

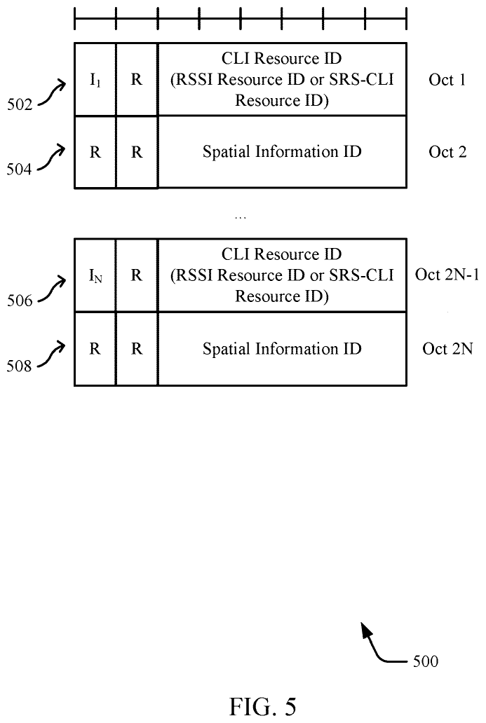

FIG. 5 illustrates an example of a MAC CE 500 that supports dynamic cross-link interference measurement and reporting in accordance with aspects of the present disclosure. The MAC CE 500 is a spatial information activation/deactivation MAC CE for enhanced CLI. The MAC CE 500 has a variable size and stores multiple (illustrated as N) pairs of octets. A first pair of octets 502 and 504 is illustrated, as is a second pair of octets 506 and 508.

Each pair of octets in the MAC CE 500 includes an Iᵢ field, CLI Resource ID field, a Spatial Information ID field, and an R field.

The Iᵢ field indicates a CLI resource type for a following CLI Resource ID field in an octet. If set to 0, the corresponding CLI resource ID field indicates a SRS resource identified by SRS-CLI-ResourceId. If set to 1, the corresponding CLI resource ID field indicates a RSSI resource identified by RSSI-ResourceId.

The CLI Resource ID field contains an identifier of the CLI resource ID identified by RSSI-ResourceId or SRS-CLI-ResourceId, which is to be activated with spatial information indicated by Spatial Information ID field in a subsequent octet. The length of the field is, in the illustrated example, 6 bits. If the indicated CLI Resource ID is included in a CLI Resource Group (configured via cli-ResourceGroupToAddModList), no other CLI resources within the same CLI resource group are indicated in the MAC CE 500, and this MAC CE 500 applies to all the CLI resources in the CLI resource group.

The Spatial Information ID field contains CLI-SpatialInfold-1 where CLI-SpatialInfold is the identifier of the CLI Spatial Information in MeasObjectCLI in which the CLI Resource ID is configured. In the illustrated example, the length of the field is 6 bits;

The R field is a Reserved bit, e.g., set to 0.

Returning to FIG. 1, in one or more implementations semi-persistent or aperiodic CLI measurement and reporting is supported. Semi-persistent CLI measurement and reporting refers to when the UE 104 receives an indication (e.g., DCI) to activate the CLI measurement and reporting, the UE 104 starts to measure the CLI resource and sends the measurement reports semi persistently, until the UE 104 receives an indication to deactivate of measurement and reporting. Aperiodic CLI measurement and reporting refers to when the UE 104 receives an indication (e.g., DCI which has a PUSCH resource allocation) to activate the CLI measurement and reporting, the UE 104, just before the PUSCH reporting, measures the CLI resource and reports the measurement in the indicated PUSCH.

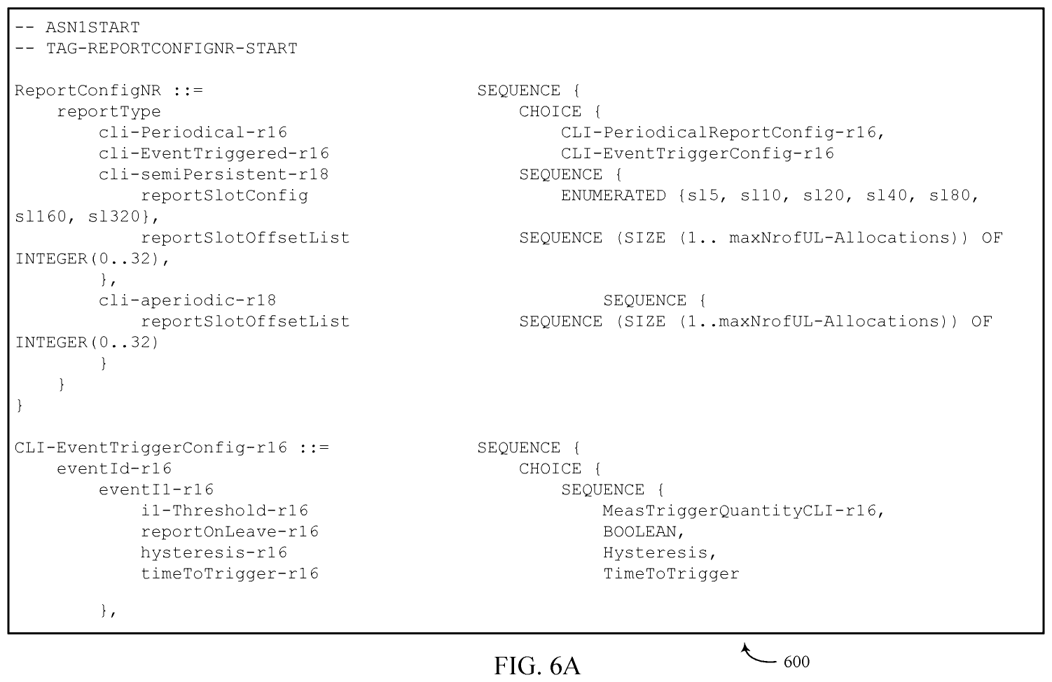

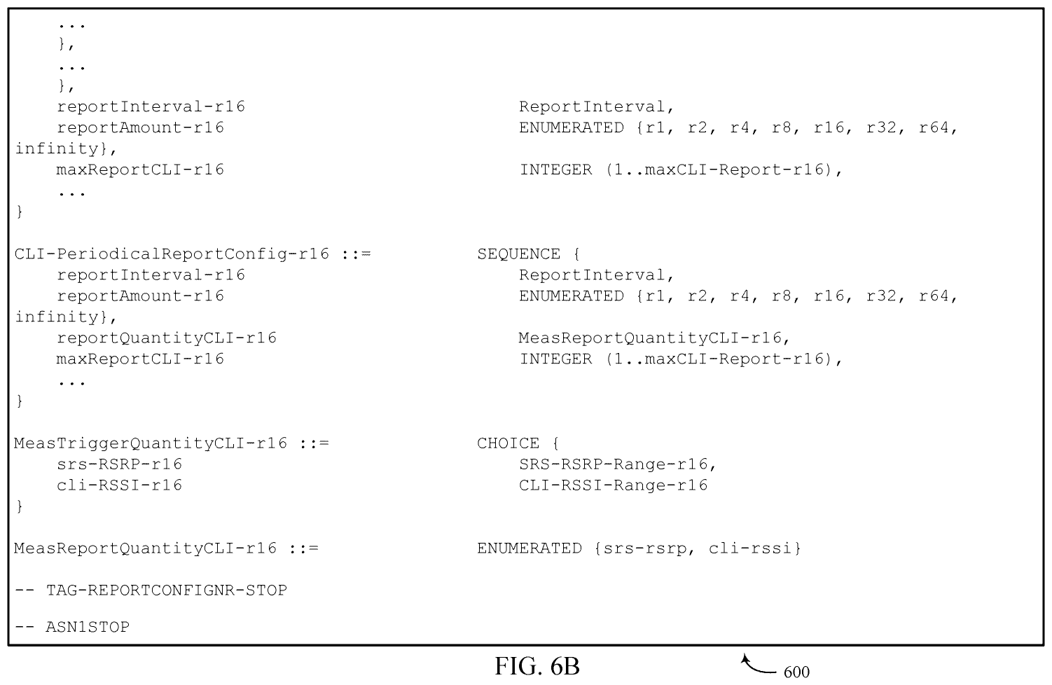

FIGS. 6A and 6B illustrate an example of an information element 600 that supports dynamic cross-link interference measurement and reporting in accordance with aspects of the present disclosure. The information element 600 is illustrated as an ReportConfigNR information element. The information element 600 specifies information, for semi-persistent or aperiodic CLI measurement reporting, applicable, e.g., for SRS-RSRP measurements and/or CLI-RSSI measurements. The information element 600 serves, for example, as a CLI measurement report configuration.

The information element 600 includes a reportSlotConfig field, which identifies a periodicity and slot offset to be used for CLI measurements.

The information element 600 also includes a reportSlotOffsetList field, which identifies a timing offset. For semi-persistent reporting, the reportSlotOffsetList field identifies a timing offset Y for semi persistent reporting using PUSCH. This field lists the allowed offset values. In one or more implementations, this list has the same number of entries as the pusch-TimeDomainAllocationList in PUSCH-Config. A particular value is indicated in DCI. The network indicates in the DCI field of the UL grant, which of the configured report slot offsets the UE 104 is to apply. The DCI value 0 corresponds to the first report slot offset in this list, the DCI value 1 corresponds to the second report slot offset in this list, and so on. The first report is transmitted in slot n+Y, second report in n+Y+P, where P is the configured periodicity.

For aperiodic reporting, the reportSlotOffsetList field identifies a timing offset Y for aperiodic reporting using PUSCH. This field lists the allowed offset values. In one or more implementations this list has the same number of entries as the pusch-TimeDomainAllocationList in PUSCH-Config. A particular value is indicated in DCI. The network indicates in the DCI field of the UL grant, which of the configured report slot offsets the UE 104 is to apply. The DCI value 0 corresponds to the first report slot offset in this list, the DCI value 1 corresponds to the second report slot offset in this list, and so on.

The information element 600 also includes a CLI-PeriodicalReportConfig field, which includes a maxReportCI field, a reportAmount field, and a reportQuantityCLI field. The maxReportCI field, identifies a maximum number of CLI measurement resources to include in the measurement report. The reportAmount field identifies a number of measurement reports, and a reportQuantityCLI field identifies measurement quantities to be included in the measurement report.

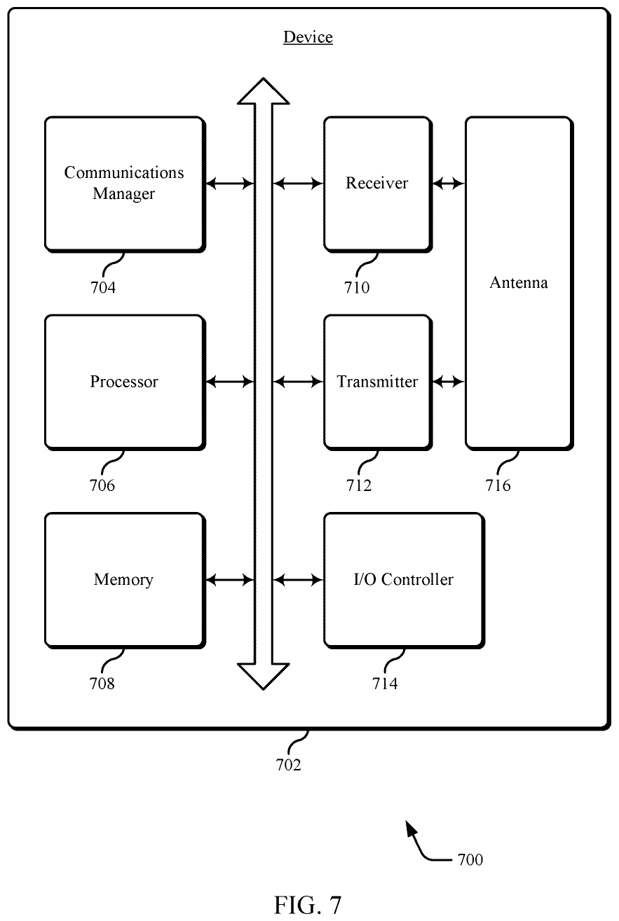

FIG. 7 illustrates an example of a block diagram 700 of a device 702 that supports dynamic cross-link interference measurement and reporting in accordance with aspects of the present disclosure. The device 702 may be an example of a UE 104 as described herein. The device 702 may support wireless communication and/or network signaling with one or more base stations 102, other UEs 104, network entities and devices, or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a UE) in accordance with examples as disclosed herein. The communications manager 704 and/or other device components may be configured as or otherwise support an apparatus, such as a UE, including a transceiver; a processor coupled to the transceiver, the processor and the transceiver configured to cause the apparatus to: receive, from a network entity, a first signaling identifying a CLI measurement configuration that includes at least one spatial information and at least one CLI resource; receive, from the network entity, a second signaling indicating to activate a spatial information of the at least one spatial information for a CLI resource of the at least one CLI resource; and perform measurements on the CLI resource based at least in part on the activated spatial information.

Additionally, the apparatus (e.g., a UE) includes any one or combination of: where the spatial information of the at least one spatial information comprises an indication of a reference signal; where the reference signal comprises a synchronization signal/physical broadcast channel block or a channel state information-reference signal resource; where the spatial information of the at least one spatial information further comprises a serving cell index, where the reference signal is associated with a serving cell indicated by the serving cell index; where the processor and the transceiver are further configured to cause the apparatus to: determine, when the spatial information does not include a serving cell index, that the reference signal is associated with a primary cell; where the processor and the transceiver are further configured to cause the apparatus to: determine, when the spatial information does not include a serving cell index, that the reference signal is associated with a serving cell where the CLI measurement configuration is received; where the second signaling comprises a MAC CE; where the processor and the transceiver are further configured to cause the apparatus to perform measurements on the CLI resource in response to the indication to activate the spatial information for the CLI resource; where the indication to activate the spatial information comprises an indication of an uplink resource for sending a CLI measurement report, and the processor and the transceiver are further configured to cause the apparatus to: transmit, to the network entity, third signaling on the indicated uplink resource indicating the CLI measurement report; where the second signaling indicates to activate semi-persistent signaling, and where to perform measurements is to perform semi-persistent measurements on the cross-link interference resource based at least in part on the activated spatial information; where the second signaling indicates to activate aperiodic signaling, and where to perform measurements is to perform aperiodic measurements on the cross-link interference resource based at least in part on the activated spatial information; where the network entity comprises a base station.

The communications manager 704 and/or other device components may be configured as or otherwise support a means for wireless communication and/or network signaling at a UE, including receiving, from a network entity, a first signaling identifying a CLI measurement configuration that includes at least one spatial information and at least one CLI resource; receiving, from the network entity, a second signaling indicating to activate a spatial information of the at least one spatial information for a CLI resource of the at least one CLI resource; and performing measurements on the CLI resource based at least in part on the activated spatial information.

Additionally, wireless communication and/or network signaling at the UE includes any one or combination of: where the spatial information of the at least one spatial information comprises an indication of a reference signal; where the reference signal comprises a synchronization signal/physical broadcast channel block or a channel state information-reference signal resource; where the spatial information of the at least one spatial information further comprises a serving cell index, where the reference signal is associated with a serving cell indicated by the serving cell index; further including: determining, when the spatial information does not include a serving cell index, that the reference signal is associated with a primary cell; further including: determining, when the spatial information does not include a serving cell index, that the reference signal is associated with a serving cell where the CLI measurement configuration is received; where the second signaling comprises a MAC CE; the performing including performing measurements on the CLI resource in response to the indication to activate the spatial information for the CLI resource; where the indication to activate the spatial information comprises an indication of an uplink resource for sending a CLI measurement report, and further including: transmitting, to the network entity, third signaling on the indicated uplink resource indicating the CLI measurement report; where the second signaling indicates to activate semi-persistent signaling, and where performing measurements comprises performing semi-persistent measurements on the cross-link interference resource based at least in part on the activated spatial information; where the second signaling indicates to activate aperiodic signaling, and where performing measurements comprises performing aperiodic measurements on the cross-link interference resource based at least in part on the activated spatial information; where the network entity comprises a base station.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

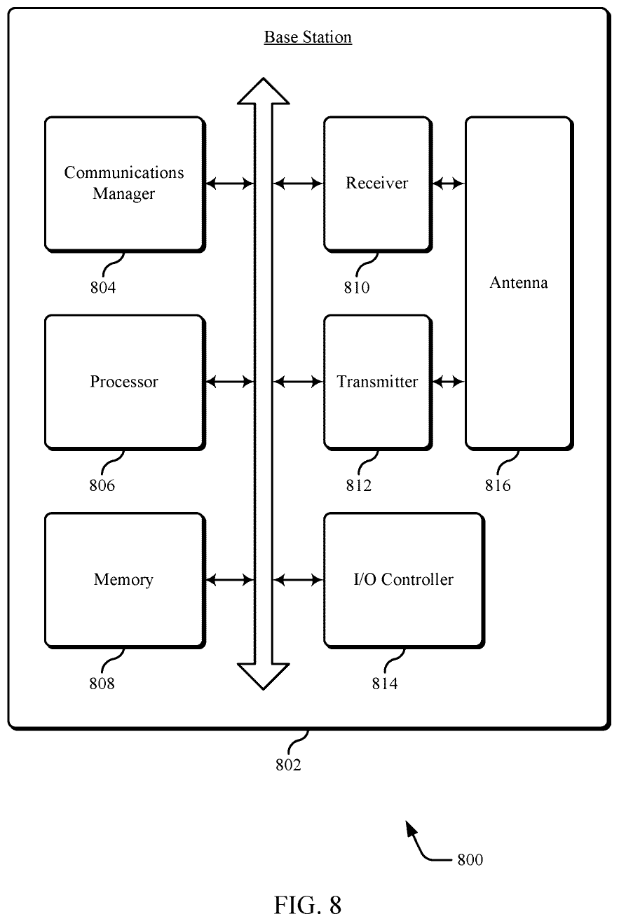

FIG. 8 illustrates an example of a block diagram 800 of a device 802 that supports dynamic cross-link interference measurement and reporting in accordance with aspects of the present disclosure. The device 802 may be an example of a base station 102 (such as a gNB) or other network device or network entity as described herein. The device 802 may support wireless communication and/or network signaling with one or more base stations 102, other UEs 104, core network devices and functions (e.g., core network 106), or any combination thereof. The device 802 may include components for bi-directional communications including components for transmitting and receiving communications, such as a communications manager 804, a processor 806, a memory 808, a receiver 810, a transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication and/or network signaling at a device (e.g., the device 802, such as a base station) in accordance with examples as disclosed herein. The communications manager 804 and/or other device components may be configured as or otherwise support an apparatus, such as a base station, or other network device or network entity, including a transceiver; a processor coupled to the transceiver, the processor and the transceiver configured to cause the apparatus to: transmit, to a UE, a first signaling identifying a CLI measurement configuration that includes at least one spatial information and at least one CLI resource; and transmit, to the UE, a second signaling indicating to activate a spatial information of the at least one spatial information for a CLI resource of the at least one CLI resource.

Additionally, the apparatus (e.g., a base station or other network device or network entity) includes any one or combination of: where the spatial information of the at least one spatial information comprises an indication of a reference signal; where the reference signal comprises a synchronization signal/physical broadcast channel block or a channel state information-reference signal resource; where the spatial information of the at least one spatial information further comprises a serving cell index, where the reference signal is associated with a serving cell indicated by the serving cell index; where the second signaling comprises a MAC CE; where the indication to activate the spatial information comprises an indication of an uplink resource for sending a CLI measurement report, and the processor and the transceiver are further configured to cause the apparatus to: receive, from the UE, third signaling on the indicated uplink resource indicating the CLI measurement report; where the second signaling indicates to activate semi-persistent signaling to receive semi-persistent CLI measurement reports from the UE; where the second signaling indicates to activate aperiodic signaling to receive an aperiodic CLI measurement report from the UE; where the apparatus comprises a base station.

The communications manager 804 and/or other device components may be configured as or otherwise support a means for wireless communication and/or network signaling at a base station or other network device or network entity, including transmitting, to a UE, a first signaling identifying a CLI measurement configuration that includes at least one spatial information and at least one CLI resource; and transmitting, to the UE, a second signaling indicating to activate a spatial information of the at least one spatial information for a CLI resource of the at least one CLI resource.

Additionally, wireless communication at the base station or other network device or network entity includes any one or combination of: where the spatial information of the at least one spatial information comprises an indication of a reference signal; where the reference signal comprises a synchronization signal/physical broadcast channel block or a channel state information-reference signal resource; where the spatial information of the at least one spatial information further comprises a serving cell index, where the reference signal is associated with a serving cell indicated by the serving cell index; where the second signaling comprises a MAC CE; where the indication to activate the spatial information comprises an indication of an uplink resource for sending a CLI measurement report, and further including: receiving, from the UE, third signaling on the indicated uplink resource indicating the CLI measurement report; where the second signaling indicates to activate semi-persistent signaling to receive semi-persistent CLI measurement reports from the UE; where the second signaling indicates to activate aperiodic signaling to receive an aperiodic CLI measurement report from the UE; where the method is implemented in a base station.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

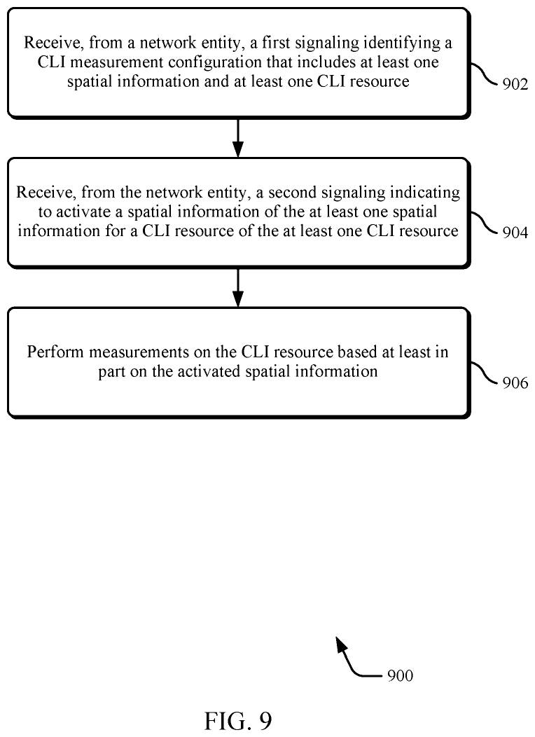

FIG. 9 illustrates a flowchart of a method 900 that supports dynamic cross-link interference measurement and reporting in accordance with aspects of the present disclosure. The operations of the method 900 may be implemented and performed by a device or its components, such as a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving, from a network entity, a first signaling identifying a CLI measurement configuration that includes at least one spatial information and at least one CLI resource. The operations of 902 may be performed in accordance with examples as described herein. In some implementations, aspects of the operations of 902 may be performed by a device as described with reference to FIG. 1.

At 904, the method may include receiving, from the network entity, a second signaling indicating to activate a spatial information of the at least one spatial information for a CLI resource of the at least one CLI resource. The operations of 904 may be performed in accordance with examples as described herein. In some implementations, aspects of the operations of 904 may be performed by a device as described with reference to FIG. 1.

At 906, the method may include performing measurements on the CLI resource based at least in part on the activated spatial information. The operations of 906 may be performed in accordance with examples as described herein. In some implementations, aspects of the operations of 906 may be performed by a device as described with reference to FIG. 1.

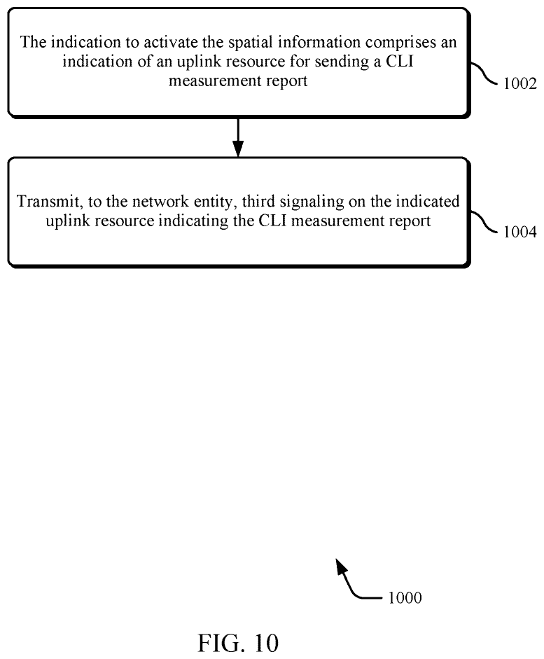

FIG. 10 illustrates a flowchart of a method 1000 that supports dynamic cross-link interference measurement and reporting in accordance with aspects of the present disclosure. The operations of the method 1000 may be implemented and performed by a device or its components, such as a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include the indication to activate the spatial information comprises an indication of an uplink resource for sending a CLI measurement report. The operations of 1002 may be performed in accordance with examples as described herein. In some implementations, aspects of the operations of 1002 may be performed by a device as described with reference to FIG. 1.

At 1004, the method may include transmitting, to the network entity, third signaling on the indicated uplink resource indicating the CLI measurement report. The operations of 1004 may be performed in accordance with examples as described herein. In some implementations, aspects of the operations of 1004 may be performed by a device as described with reference to FIG. 1.

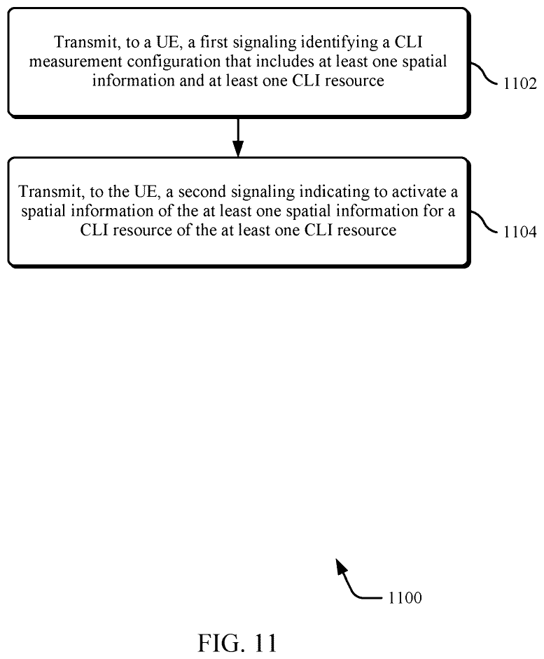

FIG. 11 illustrates a flowchart of a method 1100 that supports dynamic cross-link interference measurement and reporting in accordance with aspects of the present disclosure. The operations of the method 1100 may be implemented and performed by a device or its components, such as a base station 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include transmitting, to a UE, a first signaling identifying a CLI measurement configuration that includes at least one spatial information and at least one CLI resource. The operations of 1102 may be performed in accordance with examples as described herein. In some implementations, aspects of the operations of 1102 may be performed by a device as described with reference to FIG. 1.

At 1104, the method may include transmitting, to the UE, a second signaling indicating to activate a spatial information of the at least one spatial information for a CLI resource of the at least one CLI resource. The operations of 1104 may be performed in accordance with examples as described herein. In some implementations, aspects of the operations of 1104 may be performed by a device as described with reference to FIG. 1.

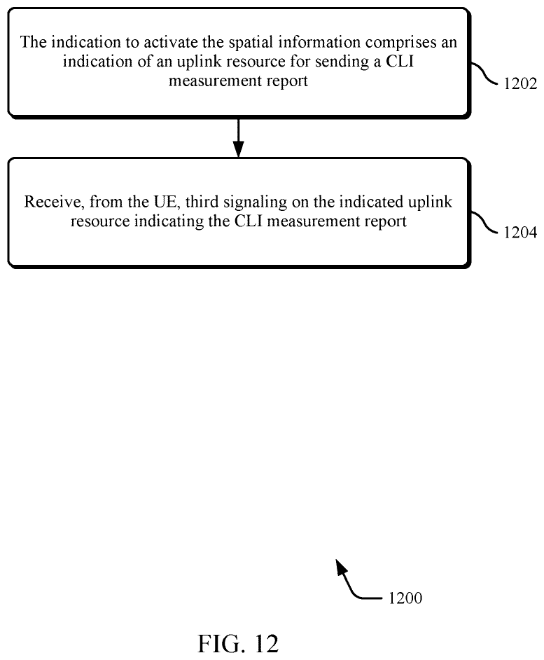

FIG. 12 illustrates a flowchart of a method 1200 that supports dynamic cross-link interference measurement and reporting in accordance with aspects of the present disclosure. The operations of the method 1200 may be implemented and performed by a device or its components, such as a base station 102 (e.g., a gNB) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include the indication to activate the spatial information comprises an indication of an uplink resource for sending a CLI measurement report. The operations of 1202 may be performed in accordance with examples as described herein. In some implementations, aspects of the operations of 1202 may be performed by a device as described with reference to FIG. 1.

At 1204, the method may include receiving, from the UE, third signaling on the indicated uplink resource indicating the CLI measurement report. The operations of 1204 may be performed in accordance with examples as described herein. In some implementations, aspects of the operations of 1204 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Similarly, a list of at least one of A; B; or C means A or B or C, or AB or AC or BC, or ABC (i.e., A and B and C). Similarly, a list of one or more of A; B; or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a network entity, a first signaling identifying a cross-link interference (CLI) measurement configuration that includes at least one spatial information and at least one CLI resource;
receive, from the network entity, a second signaling indicating to activate a spatial information of the at least one spatial information for a CLI resource of the at least one CLI resource; and
perform measurements on the CLI resource based at least in part on the activated spatial information.

2. The UE of claim 1, wherein the spatial information of the at least one spatial information comprises an indication of a reference signal.

3. The UE of claim 2, wherein the reference signal comprises a synchronization signal/physical broadcast channel block or a channel state information-reference signal resource.

4. The UE of claim 2, wherein the spatial information of the at least one spatial information further comprises a serving cell index, wherein the reference signal is associated with a serving cell indicated by the serving cell index.

5. The UE of claim 2, wherein the at least one processor is further configured to cause the UE to:
determine, when the spatial information does not include a serving cell index, that the reference signal is associated with a primary cell.

6. The UE of claim 2, wherein the at least one processor is further configured to cause the UE to:
determine, when the spatial information does not include a serving cell index, that the reference signal is associated with a serving cell where the CLI measurement configuration is received.

7. The UE of claim 1, wherein the second signaling comprises a medium access control (MAC) control element (CE).

8. The UE of claim 1, wherein the second signaling indicating to activate the spatial information comprises an indication of an uplink resource for sending a CLI measurement report, and the at least one processor is further configured to cause the UE to:
perform measurements on the CLI resource in response to the second signaling indicating to activate the spatial information for the CLI resource; and
transmit, to the network entity, a third signaling on the indicated uplink resource indicating the CLI measurement report.

9. (canceled)

10. The UE of claim 1, wherein the second signaling indicates to activate semi-persistent signaling, and wherein to perform measurements is to perform semi-persistent measurements on the CLI resource based at least in part on the activated spatial information.

11. The UE of claim 1, wherein the second signaling indicates to activate aperiodic signaling, and wherein to perform measurements is to perform aperiodic measurements on the CLI resource based at least in part on the activated spatial information.

12. The UE of claim 1, wherein the network entity comprises a base station.

13. A base station for wireless communication, comprising:
at least one memory; and
at least one processor coupled with the at least one memory and configured to cause the base station to:
transmit, to a user equipment (UE), a first signaling identifying a cross-link interference (CLI) measurement configuration that includes at least one spatial information and at least one CLI resource; and
transmit, to the UE, a second signaling indicating to activate a spatial information of the at least one spatial information for a CLI resource of the at least one CLI resource.

14. The base station of claim 13, wherein the spatial information of the at least one spatial information comprises an indication of a reference signal, and wherein the reference signal comprises a synchronization signal/physical broadcast channel block or a channel state information-reference signal resource.

15. (canceled)

16. (canceled)

17. The base station of claim 13, wherein the second signaling comprises a medium access control (MAC) control element (CE).

18. The base station of claim 13, wherein the second signaling indication to activate the spatial information comprises an indication of an uplink resource for sending a CLI measurement report, and the at least one processor is further configured to cause the base station to:
receive, from the UE, third signaling on the indicated uplink resource indicating the CLI measurement report.

19. The base station of claim 13, wherein the second signaling indicates to activate semi-persistent signaling to receive semi-persistent CLI measurement reports from the UE.

20. A method performed by a user equipment (UE), the method comprising:
receiving, from a network entity, a first signaling identifying a cross-link interference (CLI) measurement configuration that includes at least one spatial information and at least one CLI resource;
receiving, from the network entity, a second signaling indicating to activate a spatial information of the at least one spatial information for a CLI resource of the at least one CLI resource; and
performing measurements on the CLI resource based at least in part on the activated spatial information.

21. A processor for wireless communication, comprising:
at least one controller coupled with at least one memory and configured to cause the processor to:
receive, from a network entity, a first signaling identifying a cross-link interference (CLI) measurement configuration that includes at least one spatial information and at least one CLI resource;
receive, from the network entity, a second signaling indicating to activate a spatial information of the at least one spatial information for a CLI resource of the at least one CLI resource; and
perform measurements on the CLI resource based at least in part on the activated spatial information.

22. The processor of claim 21, wherein the spatial information of the at least one spatial information comprises an indication of a reference signal.

23. The processor of claim 21, wherein the second signaling indicating to activate the spatial information comprises an indication of an uplink resource for sending a CLI measurement report, and the at least one controller is further configured to cause the processor to:
perform measurements on the CLI resource in response to the second signaling indicating to activate the spatial information for the CLI resource; and
transmit, to the network entity, a third signaling on the indicated uplink resource indicating the CLI measurement report.
